(19) United States
(12) Patent Application Publication
(10) Pub. No.: US 2025/0128625 A1
(43) Pub. Date: Apr. 24, 2025

(54) VEHICLE CHARGING DEVICE

(71) Applicants: YAZAKI CORPORATION, Tokyo (JP); ShinMaywa Industries, Ltd., Takarazuka-shi (JP)

(72) Inventors: Yukinari Naganishi, Susono-shi (JP); Shigeru Yoneda, Susono-shi (JP); Takashi Shiroki, Susono-shi (JP); Nobuo Yoneyama, Takarazuka-shi (JP); Hajime Ojiro, Takarazuka-shi (JP)

(21) Appl. No.: 18/882,693

(22) Filed: Sep. 11, 2024

(30) Foreign Application Priority Data
Oct. 24, 2023 (JP) 2023-182743

(51) Int. Cl. B60L 53/35

(52) U.S. Cl. CPC B60L 53/35

(57) ABSTRACT

A vehicle charging device includes a device main body; a linear guide member that extends in a first direction, and that guides movement of the device main body; and a cover structure. The guide member is disposed such that a part of the guide member protrudes from the device main body, when the device main body moves in the first direction. The cover structure includes a cover body that covers a portion of the guide member protruding from the device main body, and a locking part. The locking part is disposed on an end part of the guide member in the first direction, and is configured to lock a tip end part of the cover body. The cover body is drawn out from the device main body to cover the guide member, when the device main body moves while the tip end part is locked by the locking part.

### CROSS-REFERENCE TO RELATED APPLICATION(S)

The present application claims priority to and incorporates by reference the entire contents of Japanese Patent Application No. 2023-182743 filed in Japan on Oct. 24, 2023.

### BACKGROUND OF THE INVENTION

### 1. Field of the Invention

The present invention relates to a vehicle charging device.

### 2. Description of the Related Art

Conventionally, charging devices for charging vehicles have been known. A vehicle charging system disclosed in Japanese Patent Application Laid-open No. 2022-26379 includes a power feeding device that includes a power feeding fitting body and that is provided in a parking space of a vehicle. The vehicle charging system includes an insertion/removal direction moving part that allows the power feeding fitting body to be fitted to a power receiving fitting body of the vehicle.

As a unit for adjusting the position of a charging device according to the stop position of the vehicle, a linear guide member may be used. Meanwhile, if the guide member is exposed to the external space when the device main body of the charging device moves along the guide member, foreign matters tend to adhere easily. It is desirable to protect the guide member against foreign matters.

### SUMMARY OF THE INVENTION

An object of the present invention is to provide a vehicle charging device that can protect the guide member.

In order to achieve the above mentioned object, a vehicle charging device according to one aspect of the present invention includes a device main body that charges a vehicle; a linear guide member that extends in a first direction, and that guides movement of the device main body along the first direction; and a cover structure that covers the guide member, wherein the guide member is disposed such that a part of the guide member protrudes from the device main body, when the device main body moves in the first direction, the cover structure includes a cover body that covers a portion of the guide member protruding from the device main body, and a locking part, the locking part is disposed on an end part of the guide member in the first direction, and is configured to lock a tip end part of the cover body, and the cover body is drawn out from the device main body to cover the guide member, when the device main body moves while the tip end part is locked by the locking part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a vehicle charging device according to an embodiment;

FIG. 2 is a sectional view of the vehicle charging device according to the embodiment;

FIG. 3 is a sectional view of a cover structure according to the embodiment;

FIG. 4 is a sectional view of the cover structure according to the embodiment;

FIG. 5 is a plan view of the cover structure according to the embodiment;

FIG. 6 is a sectional view of the cover structure according to the embodiment;

FIG. 7 is a front view of the cover structure according to the embodiment;

FIG. 8 is a side view of the cover structure according to the embodiment;

FIG. 9 is a sectional view of the cover structure according to the embodiment;

FIG. 10 is a side view of the cover structure according to the embodiment;

FIG. 11 is a sectional view of the cover structure according to the embodiment;

FIG. 12 is a side view of the cover structure according to the embodiment;

FIG. 13 is a sectional view of the cover structure according to the embodiment;

FIG. 14 is a side view of the cover structure according to the embodiment;

FIG. 15 is a perspective view of the cover structure according to the embodiment; and

FIG. 16 is a perspective view illustrating an example of a cover body.

### DETAILED DESCRIPTION OF THE PREFERRED EMBODIMENTS

Hereinafter, a vehicle charging device according to an embodiment of the present invention will be described in detail with reference to the accompanying drawings. However, the invention is not limited to the embodiment. Moreover, components in the following embodiment include those that can be easily assumed by those skilled in the art, or those that are substantially the same.

### Embodiment

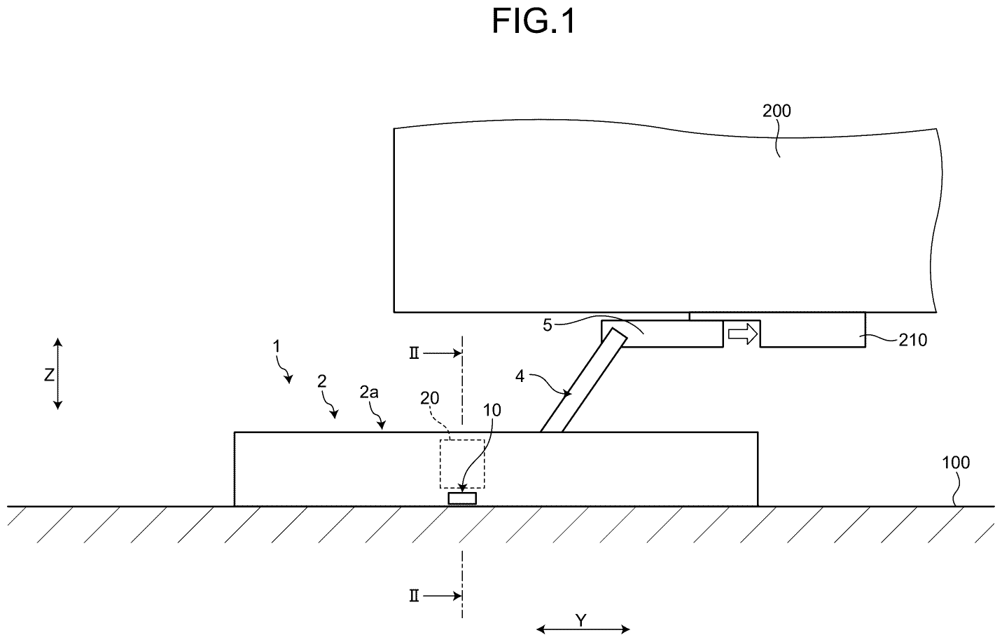

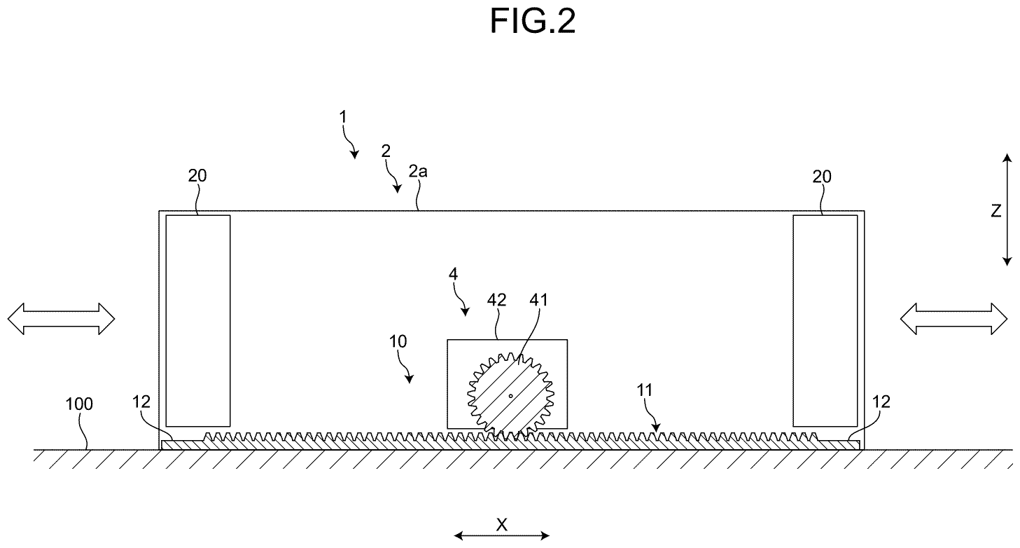

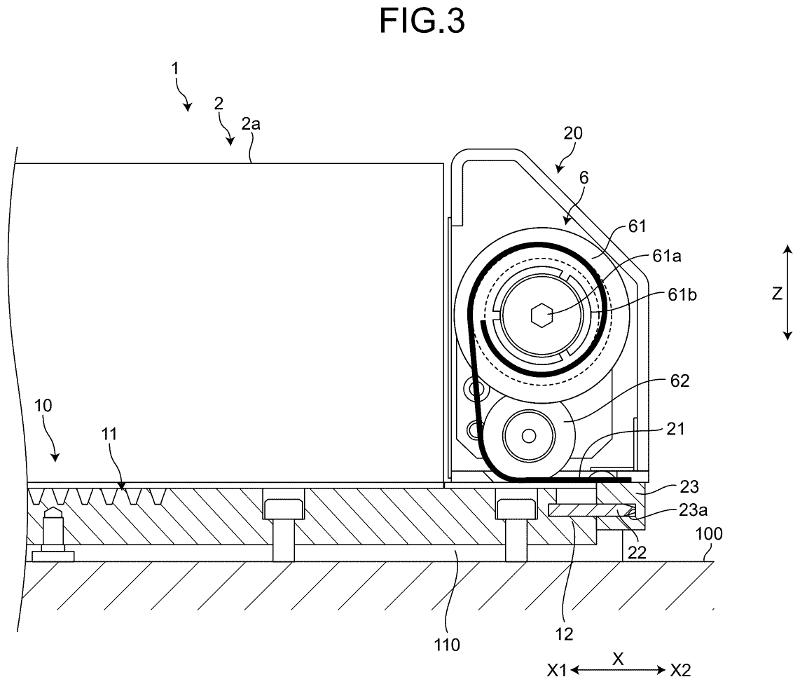

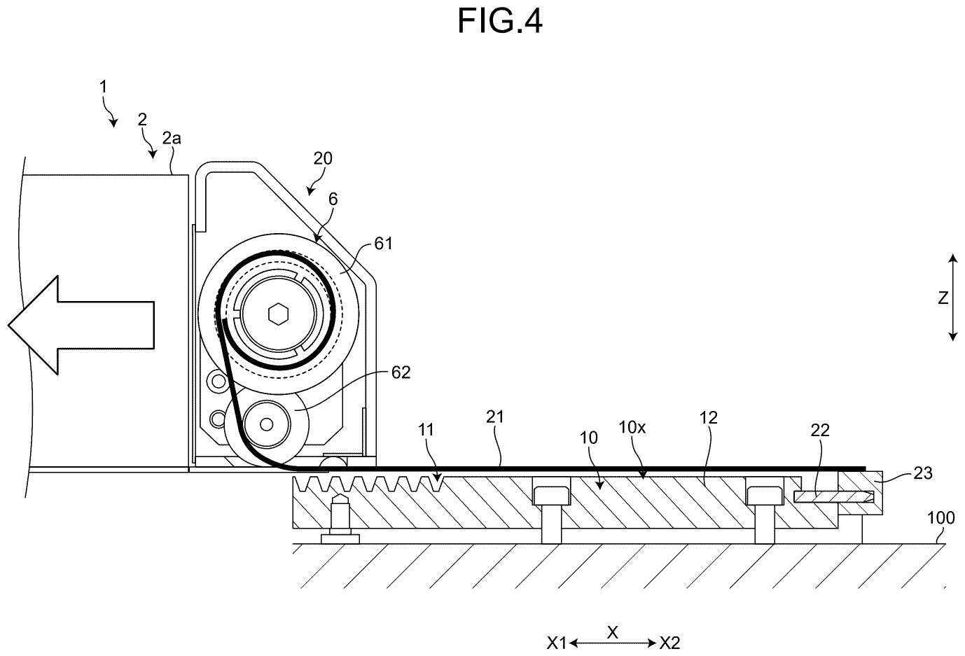

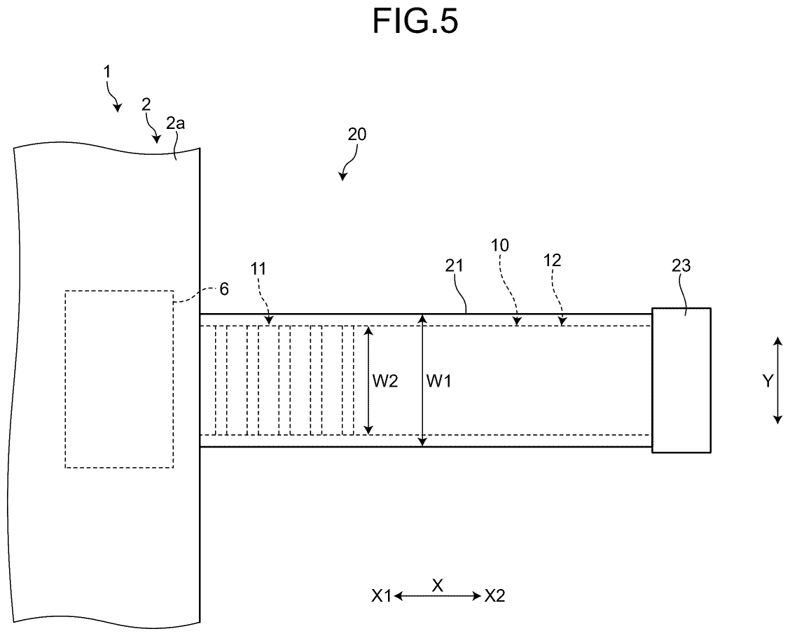

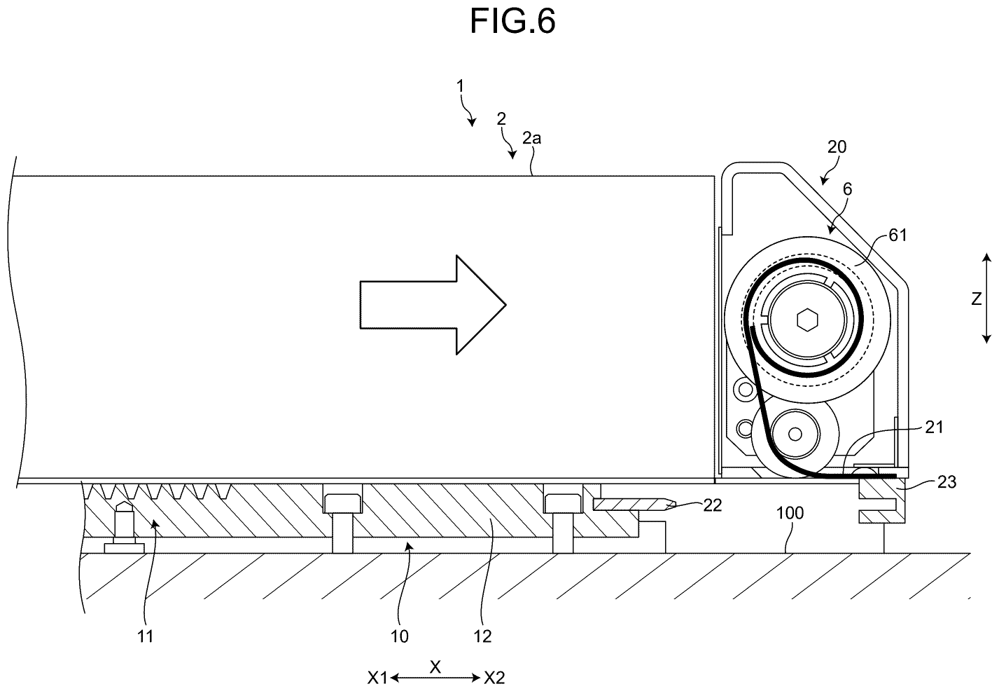

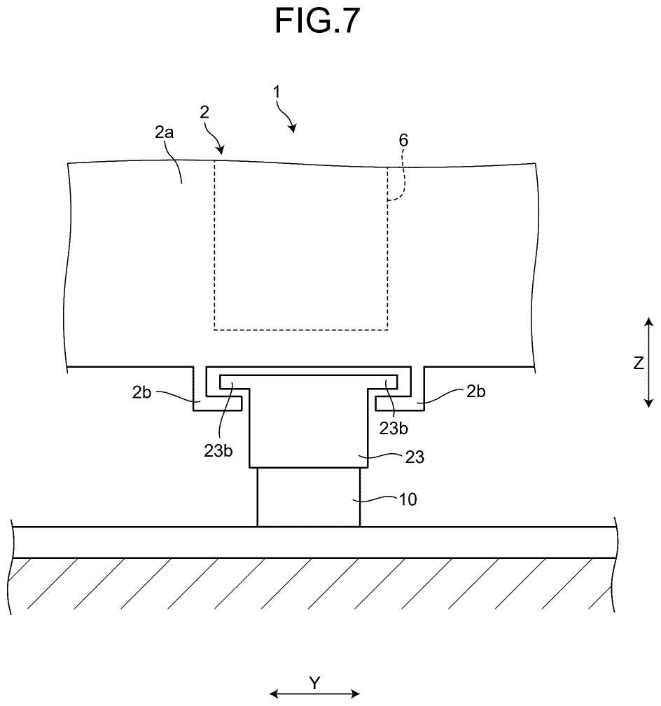

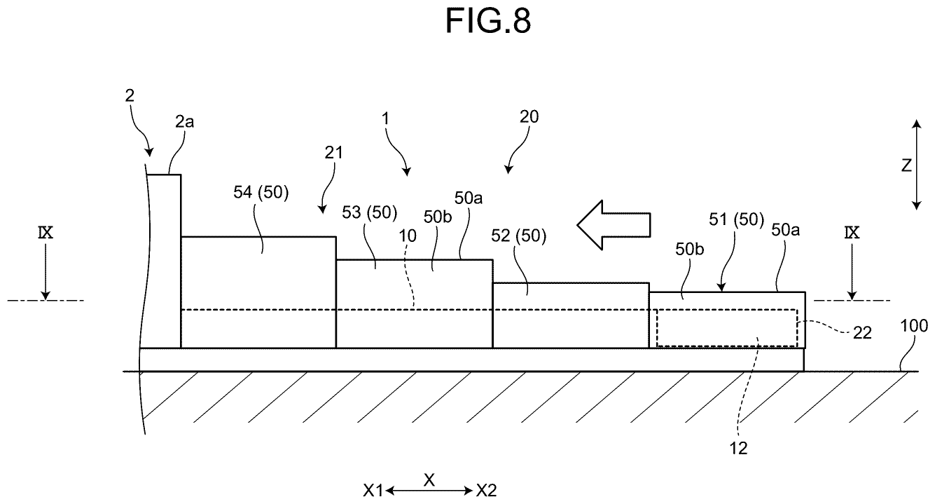

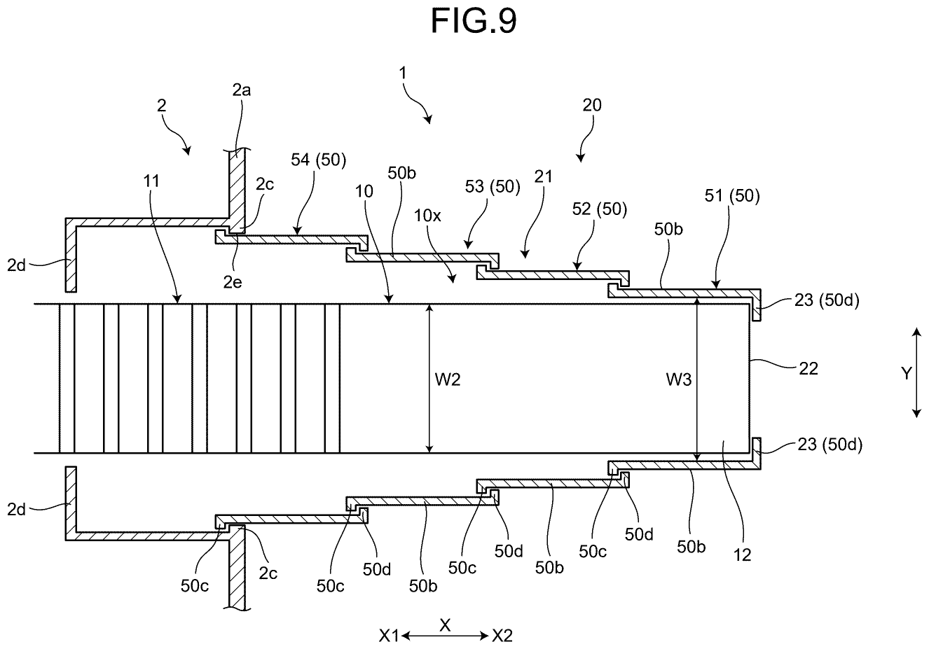

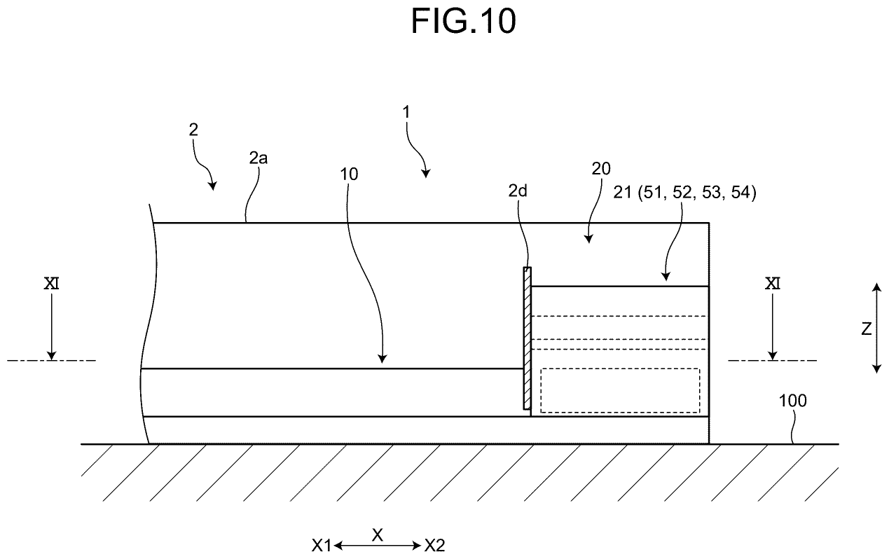

An embodiment will be described with reference to FIG. 1 to FIG. 15. The present embodiment relates to a vehicle charging device. FIG. 1 is a side view of a vehicle charging device according to an embodiment. FIG. 2 is a sectional view of the vehicle charging device according to the embodiment. FIG. 3 and FIG. 4 are sectional views of a cover structure according to the embodiment. FIG. 5 is a plan view of the cover structure according to the embodiment. FIG. 6 is a sectional view of the cover structure according to the embodiment. FIG. 7 is a front view of the cover structure according to the embodiment. FIG. 8 is a side view of the cover structure according to the embodiment. FIG. 9 is a sectional view of the cover structure according to the embodiment. FIG. 10 is a side view of the cover structure according to the embodiment.

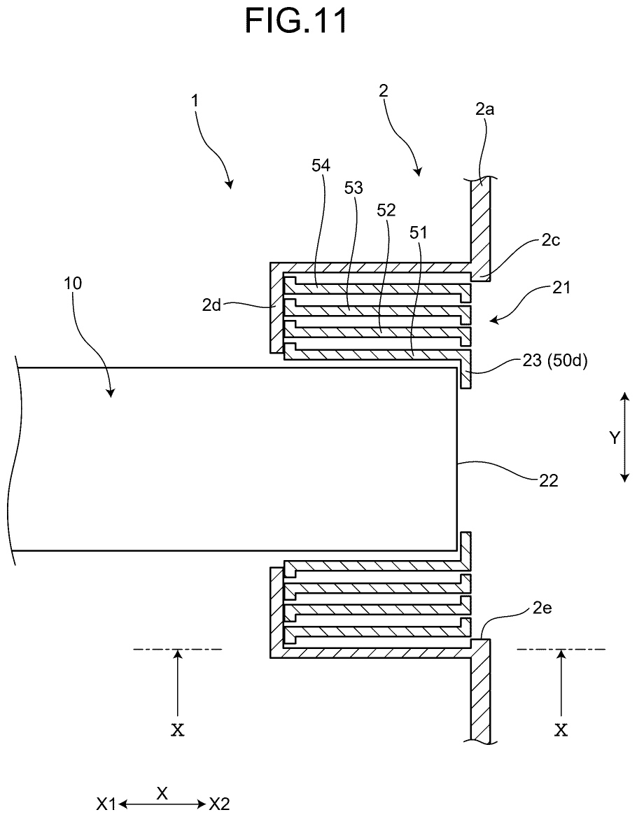

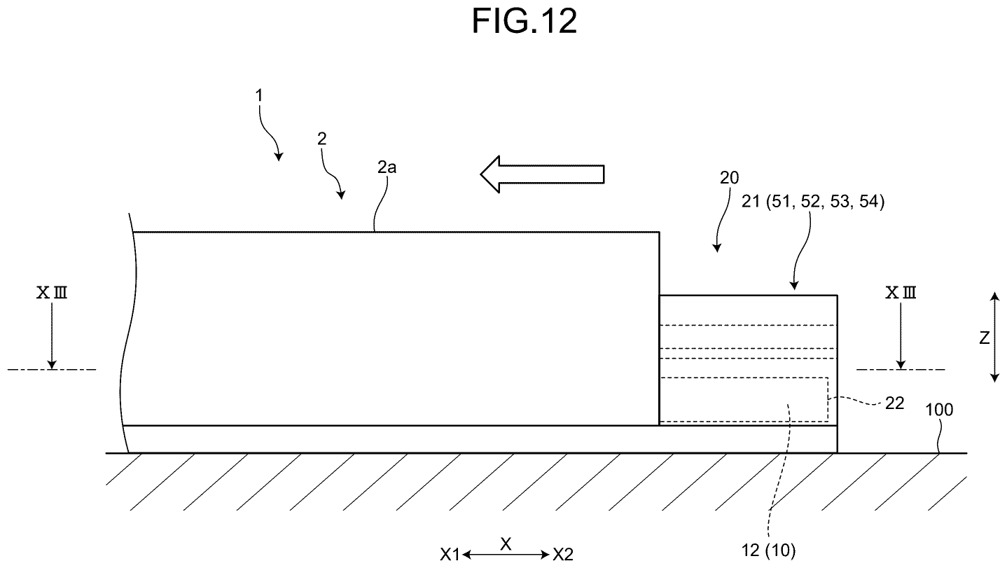

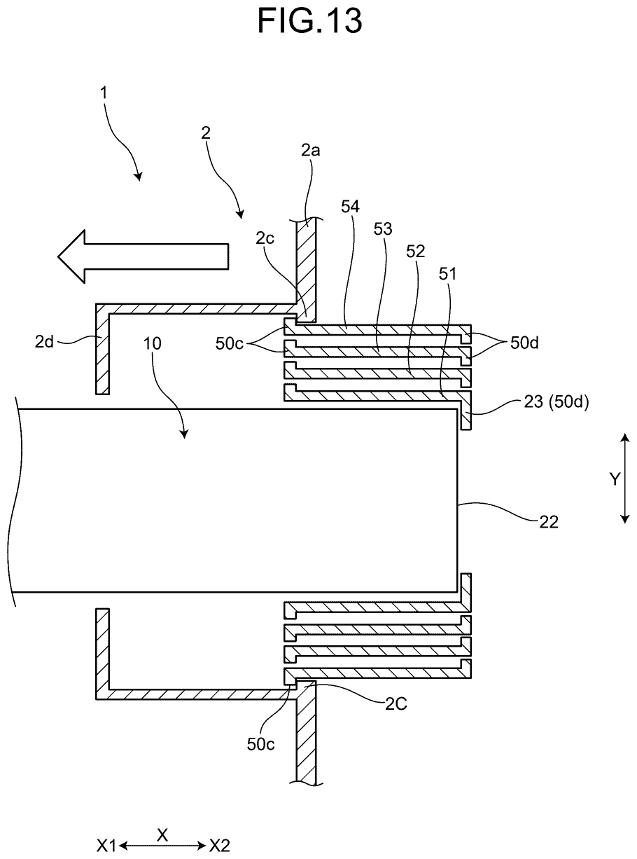

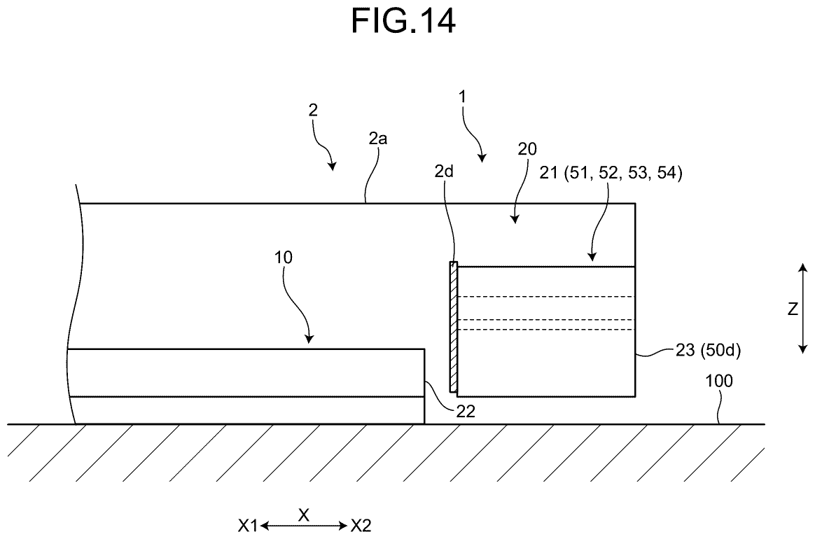

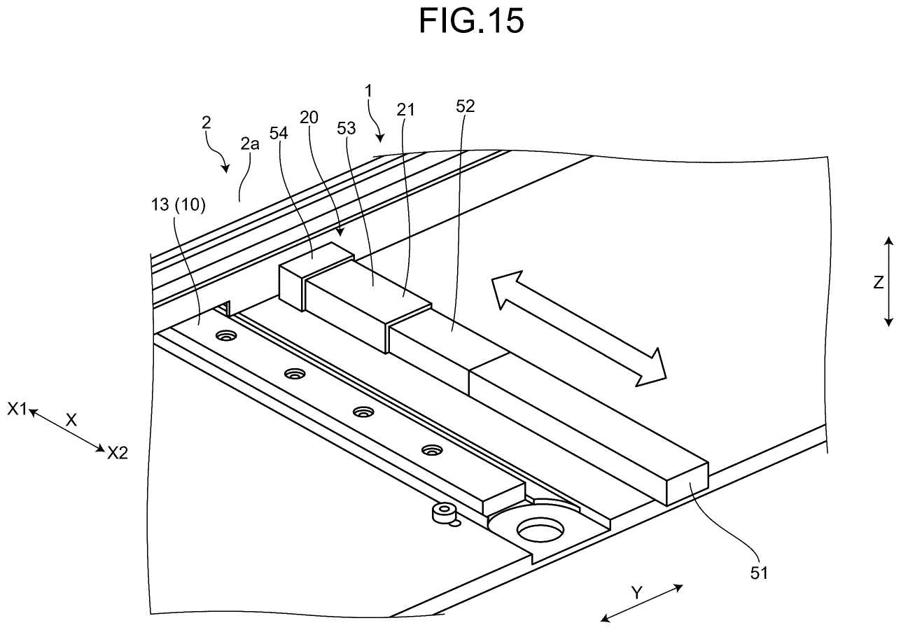

FIG. 11 is a sectional view of the cover structure according to the embodiment. FIG. 12 is a side view of the cover structure according to the embodiment. FIG. 13 is a sectional view of the cover structure according to the embodiment. FIG. 14 is a side view of the cover structure according to the embodiment. FIG. 15 is a perspective view of the cover structure according to the embodiment. FIG. 2 illustrates a cross section taken along the line II-II in FIG. 1. FIG. 9 illustrates a cross section taken along the line IX-IX in FIG. 8. FIG. 11 illustrates a cross section taken along the line XI-XI in FIG. 10. FIG. 13 illustrates a cross section taken along the line XIII-XIII in FIG. 12.

As illustrated in FIG. 1, a vehicle charging device 1 of the present embodiment is a device that charges a vehicle 200. The vehicle charging device 1 is disposed on a floor part 100 of a charging stand, a parking lot, and the like. A charging inlet 210 is disposed on the bottom of the vehicle 200. The vehicle charging device 1 includes a device main body 2 that charges the vehicle 200, a guide member 10, and a cover structure 20. As will be described below, the cover structure 20 is configured to cover a portion of the guide member 10 protruding from the device main body 2.

The device main body 2 includes a housing 2a, a moving mechanism 4, and a connector 5. The housing 2a houses components including the moving mechanism 4 and the connector 5 therein. For example, the housing 2a is formed in a rectangular parallelepiped shape. The connector 5 is a charging connector to be fitted to the inlet 210. The charging circuit of the vehicle charging device 1 is connected to the battery of the vehicle 200 via the connector 5.

The moving mechanism 4 is a mechanism that allows the connector 5 to be fitted to the inlet 210. The moving mechanism 4 is configured to move the connector 5 in three directions. The three directions are a first direction X illustrated in FIG. 2, a second direction Y illustrated in FIG. 1, and a vertical direction Z. For example, the first direction X corresponds to a vehicle width direction of the vehicle 200. For example, the second direction Y corresponds to a vehicle longitudinal direction of the vehicle 200. The vertical direction Z corresponds to a vehicle vertical direction of the vehicle 200. The first direction X is orthogonal to the second direction Y. The vertical direction Z is orthogonal to the first direction X and the second direction Y.

For example, the moving mechanism 4 moves the connector 5 in the vertical direction Z by an arm. For example, the moving mechanism 4 moves the connector 5 in the first direction X and the second direction Y by a rack-and-pinion mechanism.

As illustrated in FIG. 2, the moving mechanism 4 includes a guide member 10, a pinion gear 41, and a motor 42. The guide member 10, the pinion gear 41, and the motor 42 configure a mechanism that moves the housing 2a in the first direction X. The guide member 10 is fixed to the floor part 100, and extends in the first direction X.

The guide member 10 is a member that extends linearly, and includes a rack gear part 11 and a pair of fixed parts 12. The rack gear part 11 includes a plurality of gear teeth aligned in the first direction X. Each of the fixed parts 12 is a portion fixed to the floor part 100. For example, the fixed part 12 is fixed to a base 110 disposed on the floor part 100 by a fastening member. The fixed parts 12 are disposed on both end parts of the guide member 10 in the first direction X. The rack gear part 11 is disposed between the two fixed parts 12.

The pinion gear 41 is a disk-shaped gear that meshes with the rack gear part 11. The motor 42 is a drive source for rotating the pinion gear 41. The motor 42 is fixed to the housing 2a. The motor 42 may also be coupled to the pinion gear 41 via a deceleration mechanism. The rotation of the pinion gear 41 causes the housing 2a and the connector 5 to move in the first direction X.

FIG. 2 illustrates the device main body 2 positioned at a standby position. The standby position is a position of the device main body 2 in a standby state, before the vehicle charging device 1 starts charging the vehicle 200. To start charging, the vehicle charging device 1 detects the position of the inlet 210, and moves the device main body 2 to a position where the connector 5 can be fitted to the inlet 210, by the moving mechanism 4.

The moving mechanism 4 can move the device main body 2 to both sides in the first direction X with respect to the standby position. When the device main body 2 is at the standby position, the rack gear part 11 is covered and hidden by the housing 2a. In other words, the rack gear part 11 is housed in the housing 2a at the standby position. The housing 2a at the standby position may also house the entire guide member 10.

The guide member 10 of the present embodiment is disposed such that a part of the guide member 10 protrudes from the device main body 2, when the device main body 2 moves in the first direction X. In other words, when the device main body 2 moves in the first direction X, a part of the guide member 10 is exposed to the external space of the housing 2a. In the vehicle charging device 1 of the present embodiment, at least a part of the rack gear part 11 may be exposed to the external space of the housing 2a. When the guide member 10 that protrudes from the housing 2a is exposed to the external space without being covered, foreign matters such as dirt and dust may adhere to the guide member 10.

The vehicle charging device 1 of the present embodiment protects the guide member 10 by the cover structure 20, which will be described below. FIG. 3 illustrates a cross section orthogonal to the second direction Y of the vehicle charging device 1. As illustrated in FIG. 3 and the like, the vehicle charging device 1 of the present embodiment includes the cover structure 20 that covers and protects the guide member 10. The cover structure 20 includes a cover body 21, a locking part 22, a part to be locked 23, and a winding mechanism 6.

The cover body 21 is a plate-like member having flexibility. For example, the material of the cover body 21 is metal, resin, rubber, and the like. The cover body 21 is formed in a tape shape, is wound up by the winding mechanism 6, or is fed from the winding mechanism 6. The part to be locked 23 is attached to the tip end part of the cover body 21. The part to be locked 23 is a member to be locked by the locking part 22. The part to be locked 23 illustrated in the example includes a recess part 23a fitted to the locking part 22. The recess part 23a is opened toward the first direction X. The part to be locked 23 in the cross section illustrated in FIG. 3 is formed in a substantially U-shape.

The locking part 22 is disposed on the end part of the guide member 10 in the first direction X. The locking part 22 illustrated in the example is fixed to the fixed part 12. The tip end part of the locking part 22 protrudes from the fixed part 12 in the first direction X. The locking part 22 illustrated in the example is formed in a rod-like shape or a plate-like shape that can be inserted into the recess part 23a of the part to be locked 23.

The winding mechanism 6 can wind up the cover body 21, and feed the cover body 21 depending on the external force applied on the cover body 21. The winding mechanism 6 includes a rotating body 61 and a roller 62. The rotating body 61 is a member around which the cover body 21 is wound, and is supported in a rotatable manner. The rotating body 61 is formed in a cylindrical shape, and has an outer peripheral surface 61b around which the cover body 21 is wound. A rotation axis 61a of the rotating body 61 extends in the second direction Y. The winding mechanism 6 includes a spring that applies an urging force to the rotating body 61 in the rotating direction. The spring urges the rotating body 61 in the rotating direction toward which the cover body 21 is wound.

The roller 62 changes the extending direction of the cover body 21. The roller 62 is disposed between the rotating body 61 and the part to be locked 23. That is, a portion of the cover body 21 between the rotating body 61 and the part to be locked 23 is wound around the roller 62. The roller 62 of the present embodiment is disposed such that the cover body 21 is pulled down from the rotating body 61. Moreover, the roller 62 is disposed such that the cover body 21 extends in the first direction X from the roller 62 toward the part to be locked 23.

FIG. 3 illustrates the cover structure 20 when the device main body 2 is at a standby position. The part to be locked 23 is fitted to the locking part 22, and is locked by the locking part 22. The part to be locked 23, the cover body 21, and the winding mechanism 6 are covered from above by the housing 2a, and are housed in the housing 2a.

The device main body 2 can move to a first side X1 and a second side X2 in the first direction X from the standby position. FIG. 4 illustrates the device main body 2 that has moved to the first side X1 from the standby position. When the device main body 2 moves to the first side X1, the guide member 10 protrudes from the device main body 2. In other words, the first side X1 is the side that increases the length of a portion 10x of the guide member 10 protruding from the device main body 2. When the device main body 2 moves to the first side X1, the fixed part 12 protrudes from the device main body 2 first. When the device main body 2 moves further to the first side X1, the rack gear part 11 protrudes from the device main body 2. In FIG. 4, the rack gear part 11 is protruding from the device main body 2.

When the device main body 2 moves to the first side X1 from the standby position, the locking part 22 locks the part to be locked 23. When the part to be locked 23 is restricted from moving to the first side X1, the cover body 21 is fed from the winding mechanism 6. The fed cover body 21 covers the guide member 10 from above, and protects the guide member 10. The cover body 21 covers the rack gear part 11, and prevents foreign matters from entering the rack gear part 11.

As illustrated in FIG. 5, a width W1 of the cover body 21 is equal to or larger than a width W2 of the guide member 10. The width W1 of the cover body 21 is preferably larger than the width W2 of the guide member 10. The cover body 21 may also extend in the second direction Y with respect to the guide member 10. The cover body 21 of the present embodiment can properly protect the rack gear part 11 and the fixed part 12 from foreign matters.

The second side X2 is the side opposite to the first side X1. When the device main body 2 moves to the second side X2 from the position illustrated in FIG. 4, the guide member 10 is housed into the device main body 2. That is to say, the second side X2 is the side that decreases the length of the portion 10x of the guide member 10 protruding from the device main body 2. When the device main body 2 moves to the second side X2 toward the standby position, the winding mechanism 6 winds up the cover body 21 onto the rotating body 61.

FIG. 6 illustrates the device main body 2 that has moved further to the second side X2 from the standby position. When the device main body 2 moves to the second side X2 from the standby position, the part to be locked 23 is detached from the locking part 22. The part to be locked 23 having been detached from the locking part 22 moves to the second side X2 with the device main body 2.

The housing 2a may also include a support part that supports the part to be locked 23 having been detached from the locking part 22. For example, as illustrated in FIG. 7, the housing 2a may also include support parts 2b that guide the part to be locked 23. The support part 2b illustrated in the example is formed in a substantially L-shape when viewed from the first direction X. The support parts 2b support piece parts 23b of the part to be locked 23 from below. Moreover, the support parts 2b face the piece parts 23b from both sides in the second direction Y, and position the part to be locked 23 in the second direction Y. The piece part 23b is slidable in the first direction X with respect to the support part 2b. The support part 2b may also include a stopper that locks the part to be locked 23, against the winding force of the winding mechanism 6. The support parts 2b hold the part to be locked 23 at a position where the part to be locked 23 can be fitted to the locking part 22. Consequently, when the device main body 2 returns to the standby position from the position illustrated in FIG. 6, the part to be locked 23 is fitted to the locking part 22.

As illustrated in FIG. 2, the vehicle charging device 1 of the present embodiment includes two cover structures 20. The two cover structures 20 are configured the same. That is, when the guide member 10 is exposed to the external space by the movement of the device main body 2, the two cover structures 20 feed the cover body 21 to cover the guide member 10 with the cover body 21. Moreover, when the guide member 10 is housed into the housing 2a by the movement of the device main body 2, the two cover structures 20 wind up the cover body 21 onto the rotating body 61. Furthermore, when the device main body 2 moves to the second side X2 with respect to the standby position, the two cover structures 20 follow the movement of the device main body 2 by detaching the part to be locked 23 from the locking part 22. In the vehicle charging device 1 of the present embodiment, when one cover structure 20 feeds the cover body 21 to cover the guide member 10, the other cover structure 20 moves with the device main body 2 while housing the cover body 21 in the housing 2a.

Consequently, even when the device main body 2 moves to either side in the first direction X from the standby position, the vehicle charging device 1 of the present embodiment can protect the guide member 10 with the cover body 21. Moreover, the part to be locked 23 of the cover structure 20 is detachable from the locking part 22. Therefore, when the device main body 2 moves to the second side X2, the cover structure 20 of the present embodiment can move with the device main body 2 without obstructing the movement of the device main body 2.

Next, another cover structure 20 according to the embodiment will be described. As illustrated in FIG. 8, the cover body 21 of the cover structure 20 may include a plurality of slide bodies 50. Each of the slide bodies 50 is formed in a semi-cylindrical shape, and covers the guide member 10 from above and from the sides. For example, the slide body 50 is formed in a rectangular trough shape. As illustrated in FIG. 8, the slide body 50 includes a top wall 50a and side walls 50b. The top wall 50a is a wall part that covers the guide member 10 from above. The side walls 50b are wall parts that cover the guide member 10 from the sides. As illustrated in FIG. 9, the slide body 50 includes the side walls 50b on both sides of the guide member 10 in the second direction Y.

The slide bodies 50 are slidable relative to each other along the first direction X. The cover body 21 illustrated in the example includes four slide bodies 50. The four slide bodies 50 include a first slide body 51, a second slide body 52, a third slide body 53, and a fourth slide body 54. The first slide body 51 is a tip end slide body that configures the tip end part of the cover body 21. A gap W3 between the side walls 50b of the first slide body 51 is larger than the width W2 of the guide member 10. The first slide body 51 is locked by the locking part 22 of the guide member 10. The locking part 22 that locks the cover body 21 in FIG. 8 is the end surface of the guide member 10 in the first direction X.

The first slide body 51 includes the part to be locked 23 that is to be locked by the locking part 22. The part to be locked 23 is a piece part protruding inward from the end part of the first slide body 51 on the second side X2. The part to be locked 23 faces the locking part 22 in the first direction X, and is locked by the locking part 22.

As illustrated in FIG. 9, the slide bodies 50 configure a telescopic cover body 21 that is expandable and contractible in the first direction X. The second slide body 52 is formed such that the first slide body 51 can be housed inside the second slide body 52. The third slide body 53 is formed such that the second slide body 52 can be housed inside the third slide body 53. The fourth slide body 54 is formed such that the third slide body 53 can be housed inside the fourth slide body 54.

Each slide body 50 includes abutting parts 50c and 50d. The abutting part 50c is a piece part of the slide body 50 protruding outward from the end part on the first side X1 along the second direction Y. The abutting part 50d is a piece part of the slide body 50 protruding inward from the end part on the second side X2 along the second direction Y. The abutting part 50d of the first slide body 51 functions as the part to be locked 23 that is to be locked by the guide member 10.

The abutting part 50c of the first slide body 51 faces the abutting part 50d of the second slide body 52 in the first direction X. When the cover body 21 is extended, the abutting part 50c of the first slide body 51 abuts on the abutting part 50d of the second slide body 52. Similarly, the abutting part 50c of the second slide body 52 abuts on the abutting part 50d of the third slide body 53, and the abutting part 50c of the third slide body 53 abuts on the abutting part 50d of the fourth slide body 54.

The housing 2a has an opening part 2e through which the cover body 21 can be drawn out. The opening part 2e is provided on the outer wall of the housing 2a facing the first direction X. The cover body 21 can be drawn out to the external space of the housing 2a via the opening part 2e.

The abutting part 50c of the fourth slide body 54 is locked by a first locking part 2c and a second locking part 2d of the housing 2a. The first locking part 2c is disposed on the second side X2 with respect to the abutting part 50c of the fourth slide body 54, and faces the abutting part 50c in the first direction X. For example, the first locking part 2c is a part of the wall part forming the opening part 2e. The second locking part 2d is disposed on the first side X1 with respect to the abutting part 50c of the fourth slide body 54, and faces the abutting part 50c in the first direction X.

The second locking part 2d is configured to face the abutting part 50c of each slide body 50. That is, the second locking part 2d is disposed so as to be able to lock the abutting parts 50c of the first slide body 51 to the fourth slide body 54.

FIG. 10 and FIG. 11 illustrate the cover body 21 when the device main body 2 is at a standby position. When the device main body 2 is at the standby position, the cover body 21 is contracted most, and is housed in the housing 2a. As illustrated in FIG. 11, the four slide bodies 51, 52, 53, and 54 are nested and overlapped with each other. The cover body 21 is housed in a housing space formed between the first locking part 2c and the second locking part 2d. The locking part 22 locks the part to be locked 23, and restricts the first slide body 51 from moving toward the first side X1.

When the device main body 2 moves to the first side X1 from the standby position, as illustrated in FIG. 12, the cover body 21 is drawn out from the housing 2a. When substantially all of the cover body 21 is drawn out from the housing 2a, as illustrated in FIG. 13, the first locking part 2c of the housing 2a abuts on the abutting part 50c of the fourth slide body 54. The first locking part 2c of the housing 2a presses the fourth slide body 54 toward the first side X1. Accordingly, the fourth slide body 54 follows the housing 2a and moves to the first side X1. In this process, the part to be locked 23 of the first slide body 51 is locked by the locking part 22 of the guide member 10.

When the device main body 2 moves further to the first side X1, the abutting part 50d of the fourth slide body 54 abuts on the abutting part 50d of the third slide body 53. Accordingly, the third slide body 53 follows the housing 2a and the fourth slide body 54, and moves to the first side X1. In this manner, the cover body 21 extends toward the first side X1 while following the movement of the housing 2a, and covers the guide member 10. When the housing 2a moves to the end part on the first side X1 in the movable range, as illustrated in FIG. 8 and FIG. 9, the cover body 21 is extended most.

When the housing 2a moves to the second side X2 from the state in which the cover body 21 is extended, the second locking part 2d of the housing 2a abuts on the abutting part 50c of the slide body 50, and compresses the cover body 21. When the housing 2a moves to the standby position, all of the slide bodies 50 are housed in the housing 2a.

FIG. 14 illustrates the cover body 21 when the housing 2a has moved to the second side X2 from the standby position. In this case, the second locking part 2d of the housing 2a abuts on the cover body 21, and moves the cover body 21 to the second side X2. The movement of the cover body 21 detaches the part to be locked 23 of the cover body 21 from the locking part 22 of the guide member 10. When the part to be locked 23 is detached from the locking part 22, the cover body 21 moves to the second side X2 with the device main body 2 while being housed in the housing 2a.

As described above, the vehicle charging device 1 of the present embodiment includes the device main body 2 that charges the vehicle 200, the linear guide member 10, and the cover structure 20 that covers the guide member 10. The guide member 10 extends in the first direction X, and guides the movement of the device main body 2 along the first direction X. The guide member 10 is disposed such that a part of the guide member 10 protrudes from the device main body 2, when the device main body 2 moves in the first direction X.

The cover structure 20 includes the cover body 21 and the locking part 22. The cover body 21 covers the portion 10x of the guide member 10 protruding from the device main body 2. The locking part 22 is disposed on the end part of the guide member 10 in the first direction X. The locking part 22 is configured to lock the tip end part of the cover body 21. When the device main body 2 moves while the tip end part of the cover body 21 is locked by the locking part 22, the cover body 21 is drawn out from the device main body 2 to cover the guide member 10. The vehicle charging device 1 of the present embodiment can protect the guide member 10 with the cover structure 20.

For example, the cover body 21 is a plate-like member having flexibility. In this case, the cover structure 20 may also include the winding mechanism 6 that winds up the cover body 21. The device main body 2 moves to the first side X1 or the second side X2. The first side X1 is the side that increases the length of the portion 10x of the guide member 10 protruding from the device main body 2. The second side X2 is the side that decreases the length of the portion 10x of the guide member 10 protruding from the device main body 2.

The winding mechanism 6 feeds the cover body 21 when the device main body 2 moves to the first side X1, and winds up the cover body 21 when the device main body 2 moves to the second side X2. Such a configuration allows the cover body 21 to be housed in a compact manner.

For example, the cover body 21 may also include the slide bodies 50 formed in a semi-cylindrical shape that slide relative to each other along the first direction X. In this case, the slide bodies 50 include the tip end slide body that configures the tip end part. The tip end slide body illustrated in the example is the first slide body 51. When the device main body 2 moves to the first side X1 while the first slide body 51 is locked by the locking part 22, the slide bodies 50 are drawn out from the device main body 2 to cover the guide member 10. Such a configuration allows the guide member 10 to be covered from the side.

The tip end part of the cover body 21 may be detachable from the locking part 22. In the present embodiment, the part to be locked 23 provided on the tip end part of the cover body 21 is detachable from the locking part 22. When the device main body 2 moves to the second side X2 and the tip end part of the cover body 21 is detached from the locking part 22, the cover body 21 moves to the second side X2 with the device main body 2 while being housed in the device main body 2. When the cover body 21 is housed in the device main body 2 in this manner, the size of the vehicle charging device 1 can be reduced.

The guide member 10 protected by the cover structure 20 is not limited to the member including the rack gear part 11. For example, the guide member 10 to be protected may also be a rail 13 illustrated in FIG. 15. The rail 13 is a guide rail in a linear guide. The device main body 2 includes a carriage guided by the rail 13. The rail 13 extends linearly in the first direction X, and guides the device main body 2. The vehicle charging device 1 may also include the cover structure 20 that covers the rail 13.

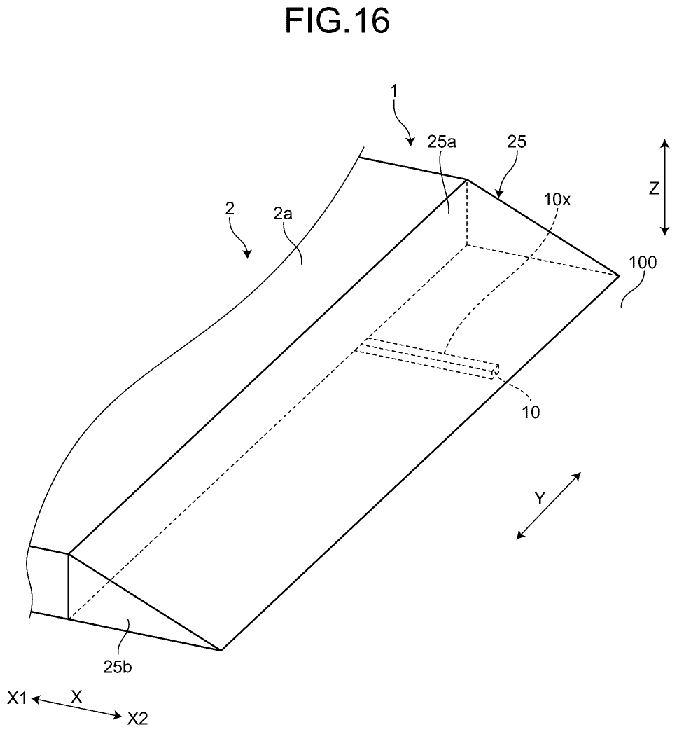

The vehicle charging device 1 may also include a cover body 25 illustrated in FIG. 16. The cover body 25 is fixed to the housing 2a, and extends from the housing 2a toward the first direction X in an eaves shape. The cover body 25 includes a top wall 25a that covers the guide member 10 from above, and side walls 25b. The top wall 25a is inclined with respect to the first direction X such that the top wall 25a approaches the floor part 100 with an increase in the distance from the device main body 2 along the first direction X. The cover body 25 is provided from one end of the housing 2a to the other end in the second direction Y. Consequently, the cover body 25 can protect a large area on the side of the housing 2a, and prevent foreign matters from entering.

When the device main body 2 moves to the first side X1, the cover body 25 can cover the portion 10x of the guide member 10 protruding from the device main body 2. For example, the length of the cover body 25 in the first direction X is defined according to the length of the movable range of the device main body 2. For example, the length of the cover body 25 is defined such that the cover body 25 can always cover the entire protruding portion 10x.

The contents disclosed in the embodiment described above can be implemented in appropriate combination.

The vehicle charging device according to the present embodiment includes the cover structure that covers the guide member. The cover structure includes the cover body that covers the portion of the guide member protruding from the device main body, and the locking part. When the device main body moves while the tip end part of the cover body is locked by the locking part, the cover body is drawn out from the device main body to cover the guide member. With the vehicle charging device according to the present invention, it is advantageously possible to protect the guide member with the cover body drawn out from the device main body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle charging device, comprising:
a device main body that charges a vehicle;
a linear guide member that extends in a first direction, and that guides movement of the device main body along the first direction; and
a cover structure that covers the guide member, wherein
the guide member is disposed such that a part of the guide member protrudes from the device main body, when the device main body moves in the first direction,
the cover structure includes a cover body that covers a portion of the guide member protruding from the device main body, and a locking part,
the locking part is disposed on an end part of the guide member in the first direction, and is configured to lock a tip end part of the cover body, and
the cover body is drawn out from the device main body to cover the guide member, when the device main body moves while the tip end part is locked by the locking part.

2. The vehicle charging device according to claim 1, wherein
the cover body is a plate-like member having flexibility,
the cover structure includes a winding mechanism that winds up the cover body,
the device main body moves to a first side that increases a length of a portion of the guide member protruding from the device main body, or a second side that decreases the length of the portion of the guide member protruding from the device main body, and
the winding mechanism feeds the cover body when the device main body moves to the first side, and winds up the cover body when the device main body moves to the second side.

3. The vehicle charging device according to claim 1, wherein
the cover body includes a plurality of slide bodies formed in a semi-cylindrical shape that slide relative to each other along the first direction,
the slide bodies include a tip end slide body that configures the tip end part,
the device main body moves to a first side that increases a length of a portion of the guide member protruding from the device main body, or a second side that decreases the length of the portion of the guide member protruding from the device main body, and
the slide bodies are pulled out from the device main body to cover the guide member, when the device main body moves to the first side while the tip end slide body is locked by the locking part.

4. The vehicle charging device according to claim 2, wherein
the tip end part of the cover body is detachable from the locking part, and
the cover body moves to the second side with the device main body while being housed in the device main body, when the device main body moves to the second side and the tip end part is detached from the locking part.

5. The vehicle charging device according to claim 3, wherein
the tip end part of the cover body is detachable from the locking part, and
the cover body moves to the second side with the device main body while being housed in the device main body, when the device main body moves to the second side and the tip end part is detached from the locking part.
